(19) United States
(12) Patent Application Publication
(10) Pub. No.: US 2010/0294715 A1
(43) Pub. Date: Nov. 25, 2010

(54) SETTLER ARRANGEMENT FOR LIQUID-LIQUID EXTRACTION, EQUIPMENT TO BE PLACED IN THE SETTLER OP LIQUID-LIQUID EXTRACTION AND METHOD FOR INSTALLING THE EQUIPMENT

(75) Inventors: Rami Saario, Espoo (FI); Jussi Pajala, Vantaa (FI)

Correspondence Address: CHERNOFF, VILHAUER, MCCLUNG & STENZEL, LLP, 601 SW Second Avenue, Suite 1600, PORTLAND, OR, 97204-3157, US

(73) Assignee: OUTOTEC OYJ, Espoo (FI)

(21) Appl. No.: 12/742,431

(22) PCT Filed: Nov. 5, 2008
(86) PCT No.: PCT/FI2008/050632

§ 371 Date: May 11, 2010

(30) Foreign Application Priority Data
Nov. 12, 2007 (FI) 20075799

(51) Int. Cl. B01D 17/025; B01D 11/04; B01D 21/02; B23P 11/00

(52) U.S. Cl. 210/521; 210/541; 29/428

(57) ABSTRACT

Equipment to be placed in the settler (6) of liquid-liquid extraction. The equipment comprises an overflow chute (10) for receiving a first solution as an overflow from the settler; a first outlet box (15) that is placed on a lower level than the overflow chute and arranged to receive the first solution from the overflow chute; a collecting chute (12) that is positioned adjacently with the overflow chute for receiving the second solution as an underflow from the settler; rising pipes (13) that extend from the collecting chute to the settler for conducting the second solution to the collecting chute; level control valves (14) arranged in the rising pipes for adjusting the level of the second solution; and a second outlet box (15) that is placed on a lower level than the collecting chute and arranged to receive the second solution from the collecting chute. The overflow chute (10), the first outlet box (11), the collecting chute (12), the rising pipes (13), the level control valves (14) and the second outlet box (15) are interconnected in order to together form an essentially rigid self-supporting subassembly (16) that can as a uniform entity be separately transferred and installed on the settler bottom. The subassembly (16) is separately manufactured in a place of manufacture, transferred as a uniform entity to the site of installation, and installed on the bottom (5) of the settler (6).

### FIELD OF THE INVENTION

The invention relates to a settler arrangement for liquid-liquid extraction, defined in the preamble of claim 1. The invention also relates to equipment to be placed in the settler of liquid-liquid extraction, defined in the preamble of claim 10. Moreover, the invention relates to a method for installing the equipment, defined in the preamble of claim 18.

### BACKGROUND OF THE INVENTION

From the prior, art, there is known a settler arrangement for liquid-liquid extraction from the publication U.S. Pat. No. 6,267,900 B1, by which a first solution and a second solution that is heavier than the first solution, can be from a dispersion of said solutions. The known settler arrangement comprises side walls and a bottom that define the settler. The settler has a feed end, through which the dispersion is fed into the settler, and a discharge end, through which the first and second solutions are arranged to be discharged as mutually separated. In between the feed and discharge ends of the settler, there are provided separating elements, such as picket fences, between which there are established successive separating steps, where the first solution is separated in an upper phase, and the second solution is separated in a lower phase underneath the upper phase. The settler discharge end is provided with an overflow chute that is positioned transversally with respect to the flowing direction and receives the first solution separated in the upper phase as an overflow from the settler. On a lower level with respect to the overflow chute, there is a first outlet box that receives the first solution from the overflow chute. In succession to the overflow chute in the flowing direction, and adjacently thereto, there is arranged a collecting chute for receiving the second solution as an underflow from the settler. From the collecting chute to the settler, there are extended rising pipes, through which the second solution can rise to the collecting chute. In the rising pipes, there are arranged level control valves, by which the level of the second solution and thereby also the overflow height of the first solution can be adjusted. On a level that is positioned lower than the collecting chute, there is arranged a second outlet box to receive the second solution from the collecting chute.

Typically current arrangements are assembled of single elements at the site of usage in the settler, which is cumbersome, expensive and time-consuming. A further problem is that in known arrangements, the outlet boxes are placed outside the settler, wherefore they take up space and can cause leaks.

### OBJECT OF THE INVENTION

The object of the invention is to eliminate the above mentioned drawbacks.

A particular object of the invention is to introduce a settler arrangement for liquid-liquid extraction, which settler arrangement can be assembled easily and rapidly with low expenses, and is compact in structure and takes up as little space as possible.

### SUMMARY OF THE INVENTION

The settler arrangement for liquid-liquid extraction according to the invention is characterized by what is set forth in the appended claim 1. Further, the equipment according to the invention is characterized by what is set forth in claim 10. Moreover, the installing method according to the invention is characterized by what is set forth in claim 18.

According to the invention, an overflow chute, a first outlet box, a collecting chute, a set of rising pipes, level control valves and a second outlet box are interconnected in order to together form an essentially rigid self-supporting subassembly that can, as one uniform entity, be transferred and installed on the bottom of a settler.

In the method according to the invention, in a place of manufacture, such as an engineering workshop, the overflow chute, the first outlet box, the collecting chute, the rising pipes, the level control valves and the second outlet box are interconnected in order to together form an essentially rigid and self-supporting subassembly. The created subassembly is transferred, as one uniform entity, to the site of installation. At the site of installation, the subassembly is installed to be supported by the settler bottom.

An advantage of the invention is that the subassembly can be manufactured in a factory and transferred as a ready-made entity to the site of usage, which makes the installation at the site of usage both easier and more rapid. The settler arrangement can be assembled easily and rapidly with low expenses, and it is compact and takes up as little space as possible.

In an embodiment of the settler arrangement and equipment, the subassembly includes an essentially vertical front wall that is parallel with the overflow chute, the upper edge of the front wall being attached to the outer side of the overflow chute, and the lower edge of said front wall extending to the vicinity of the settler bottom, so that in between the lower edge and the bottom, there is left an aperture that allows the second solution to flow through the aperture to the rising pipes.

In an embodiment of the settler arrangement and equipment, the subassembly includes support plates that are arranged transversally with respect to the lengthwise direction of the overflow and collecting chutes, spaced apart from each other underneath the overflow and collecting chutes, to which support plates the overflow chute, the collecting chute and the front wall are attached.

In an embodiment of the settler arrangement and equipment, in the support plates there are integrated legs for supporting the subassembly against the settler bottom.

In an embodiment of the settler arrangement and equipment, the overflow chute is semi-circular in cross-section.

In an embodiment of the settler arrangement and equipment, the collecting chute is semi-circular in cross-section.

In an embodiment of the settler arrangement and equipment, the first outlet box is attached underneath the overflow chute.

In an embodiment of the settler arrangement and equipment, the second outlet box is attached underneath the collecting chute.

In an embodiment of the settler arrangement and equipment, the subassembly includes a support frame that is attached rigidly with respect to the collecting chute in order to support the level control valve.

### LIST OF DRAWINGS

The invention is described in more detail below by way of exemplary preferred embodiments and with reference to the appended drawings, where

FIG. 1 is an axonometric illustration of an embodiment of a settler arrangement according to the invention, provided with a subassembly at the discharge end, viewed in a slanted direction from the top,

FIG. 1A illustrates a detail of FIG. 1,

FIG. 2 is a side-view illustration of the subassembly placed at the discharge end of the settler arrangement of FIG. 1,

FIG. 3 is a top-view illustration of the subassembly of FIG. 2,

FIG. 4 illustrates a cross-section IV-IV of FIG. 2,

FIG. 5 illustrates a cross-section V-V of FIG. 2, and

FIG. 6 is an axonometric illustration of the subassembly of FIGS. 1-5, viewed from a slanted downwardly direction.

### DETAILED DESCRIPTION OF THE INVENTION

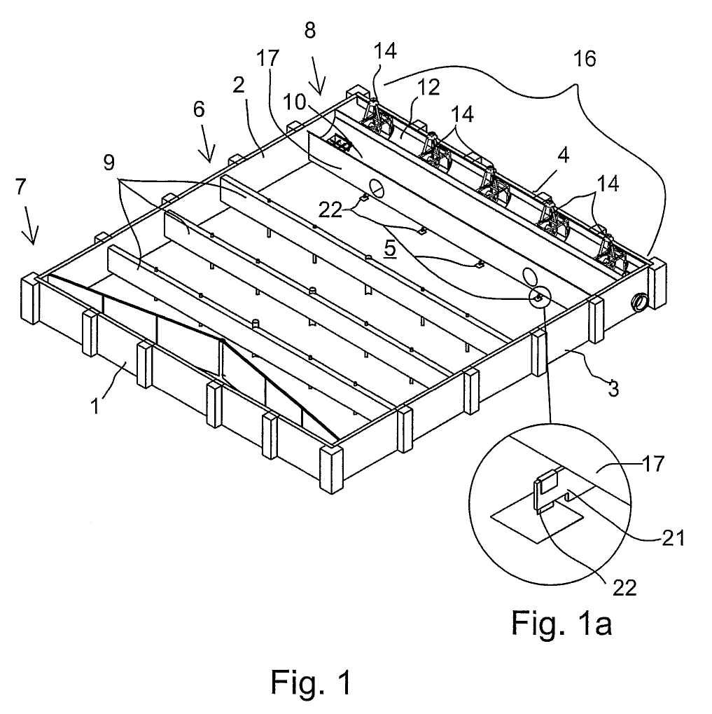

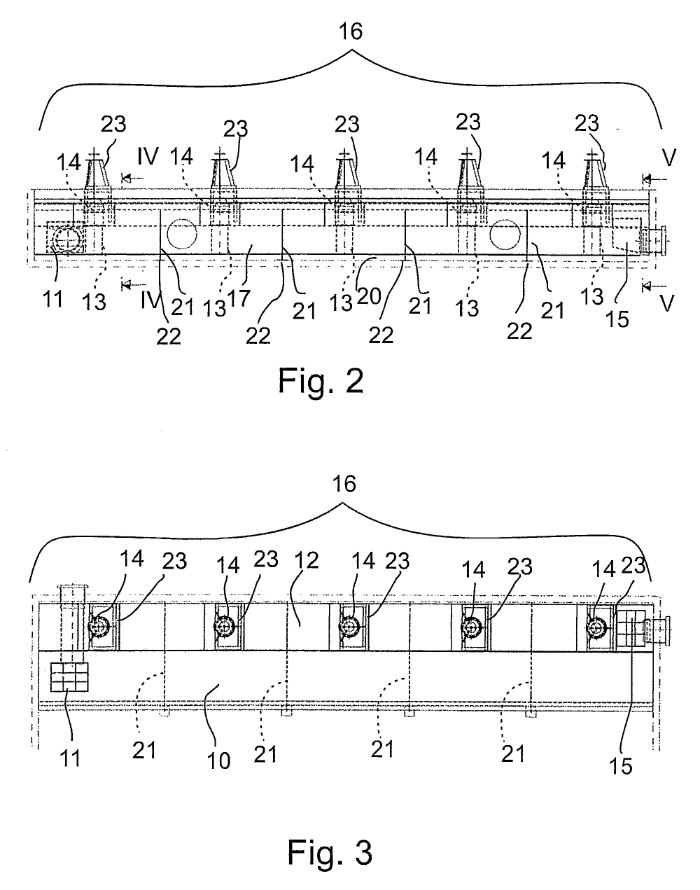

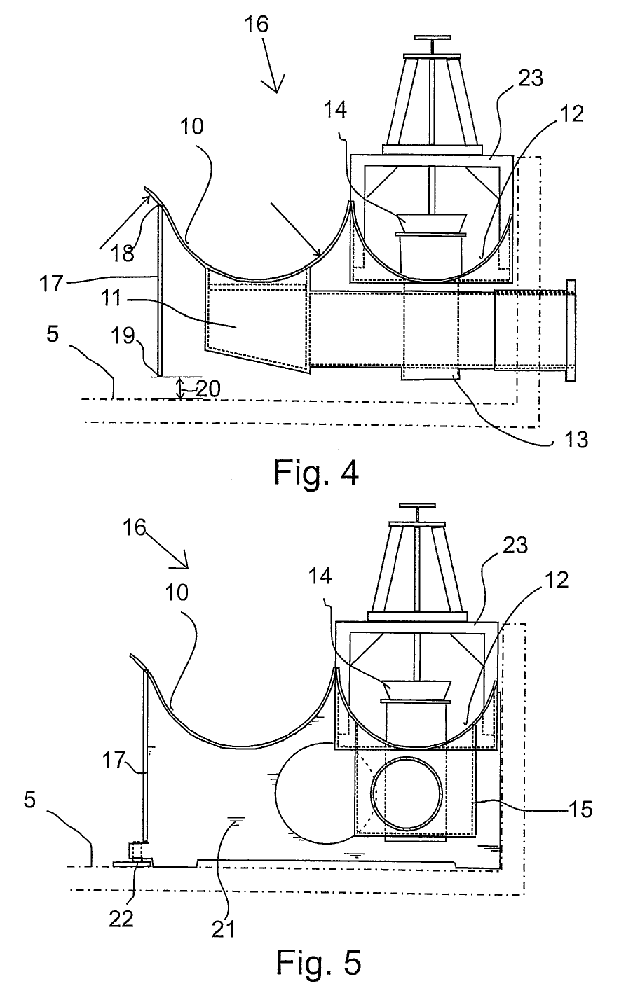

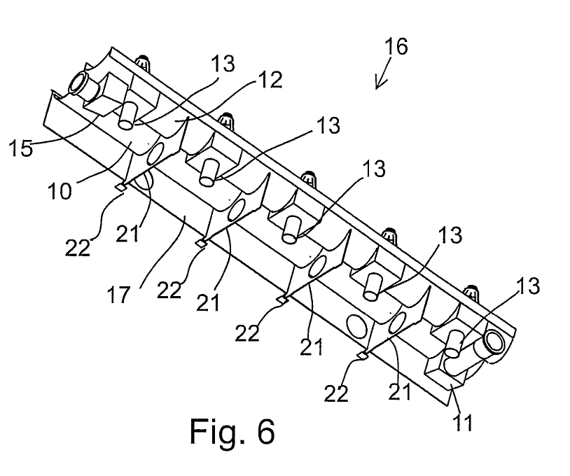

FIG. 1 illustrates a settler arrangement for liquid-liquid extraction. The settler arrangement has side walls 1, 2, 3, 4 and a horizontal bottom 5, which define a rectangular-shaped settler 6. The settler 6 need not, however, necessarily be rectangular. In another embodiment, it can also be narrowed towards the discharge end, so that either one or both of the side walls are arranged in an inclined position with respect to the front and rear walls, while the bottom is horizontal.

The settler 6 has a feed end 7, through which the dispersion is fed into the settler 6. The settler also has a discharge end 8, through which the first and second solutions that are separated into layered phases are arranged to be discharged as mutually separated.

Picket fences are arranged as separating elements 9 in the settler, in between the feed end and the discharge end, to establish successive separating steps in the flowing direction, for separating the first solution as an upper phase and for separating the second solution as a lower phase.

The discharge end 8 of the settler 6 is provided with an overflow chute 10 that is arranged transversally with respect to the flowing direction, so that it can receive as an overflow from the settler the first solution forming the topmost phase. Underneath the overflow chute 10, there is arranged a first outlet box 11, in which the first solution flows from the overflow chute 10. A collecting chute 12 is positioned after the overflow chute 10 in the flowing direction, adjacently with the overflow chute 10. The collecting chute 12 receives the second solution forming the lower phase from the settler 6. At the bottom of the collecting chute 12, there are arranged rising pipes 13, which extend from the collecting chute 12 to the settler 6, so that the second solution can rise along them to the collecting chute through level control valves 14. In the rising pipes 13, the purpose of the level control valves 14 is to adjust the level of the second solution, and in the settler their purpose is to adjust the phase boundary surface. The second outlet box 15 is arranged on a lower level with respect to the collecting chute 12, attached underneath it, and can receive second solution from the collecting chute 12. Being integrated in the subassembly 16, the outlet boxes 11 and 15 do not need a separate foundation, and because they do not extend to outside the extreme measures of the chutes, they do not need separate floor space in a factory. The outlet pipes of the outlet boxes can be positioned freely, which renders versatile possibilities for planning the industrial layout. Because the outlet boxes 11 and 15 are located inside the settler, they cannot cause leaks to outside the settler. In the drawings, the discharge pipe of the second outlet box 15 is arranged in the side wall 3. It can also be arranged in the rear wall 4.

The overflow chute 10, the first outlet box 11, the collecting chute 12, the rising pipes 13, the level control valves 14 and the second outlet box 15 are interconnected in order to together form an essentially rigid self-supporting subassembly 16 that can be transferred as a uniform entity and installed on the settler bottom.

In addition, the subassembly 16 also includes an essentially vertical front wall 17 that is parallel with the overflow chute. The front wall 17 is at its upper edge 18 attached to the external side of the overflow chute 10. The lower edge 19 of the front wall extends to the vicinity of the bottom 5 of the settler 6, so that in between the lower edge and the bottom, there is left an aperture 20, through which the second solution has access to the rising pipes 13.

Moreover, the subassembly 16 includes support plates 21 that are arranged transversally with respect to the lengthwise direction of the overflow and collecting chutes 10, 12, spaced apart from each other underneath the overflow and collecting chutes, and the overflow chute 10, the collecting chute 12 and the front wall 17 are attached to said support plates 21. This makes the structure of the subassembly extremely rigid. Also legs 22 are integrated in the support plates 21 for supporting the subassembly 16 against the bottom 5 of the settler 6. The integration of the legs 22 in the support plates 21 ensures that the subassembly does not need any other separate support legs.

Both the overflow chute 10 and the collecting chute 12 are semi-circular in cross-section, and hence they can be manufactured by cutting prefabricated pipe into half. In addition, the semi-circular shape is rigid in bending, its walls can be thin, and additional reinforcement is not needed.

In addition, the subassembly 16 includes a support frame 23, which is rigidly attached with respect to the collecting chute 12 in order to support the level control valve 14. The level control valves 14 can be readily installed at the factory. Moreover, the support frame 23 makes the structure of the subassembly 16 even more rigid.

The measures of the subassembly 16 are advantageously designed so that the subassembly fits into a freight truck trailer, in which it can be transported from the place of manufacture to the place of usage.

The invention is not restricted to the above described embodiments only, but many modifications are possible within the scope of the inventive idea defined in the appended claims.

1-16. (canceled)

17. A settler arrangement for liquid-liquid extraction for separating a first solution and a second solution, which second solution is heavier than the first solution, from a dispersion of said solutions, said settler arrangement comprising
side walls (1, 2, 3, 4) and a bottom (5) defining inside them a settler (6) provided with a feed end (7), through which the dispersion is arranged to be fed into the settler, and a discharge end (8), through which the first and second solutions are arranged to be discharged as mutually separated,
separating elements (9) that are arranged in between the feed and discharge ends of the settler to form successive separating steps for separating the first solution as an upper phase and for separating the second solution as a lower phase,
an overflow chute (10) that is arranged transversally with respect to the flowing direction at the discharge end for receiving the first solution as an overflow from the settler,
a first outlet box (11) that is placed on a lower level than the overflow chute and arranged to receive the first solution from the overflow chute,
a collecting chute (12), arranged in succession to the overflow chute in the flowing direction and adjacently with the overflow chute for receiving the second solution as an underflow from the settler,
rising pipes (13) that extend from the collecting chute to the settler for conducting the second solution in the collecting chute,
level control valves (14) that are provided with rising pipes for adjusting the level of the second solution, and
a second outlet box (15) that is placed on a lower level than the collecting chute and arranged to receive the second solution from the collecting chute, characterized in that the overflow chute (10) is semi-circular in cross-section being manufactured by cutting a prefabricated pipe into half, and that the overflow chute (10), the first outlet box (11), the collecting chute (12), the rising pipes (13), the level control valves (14) and the second outlet box (15) are interconnected in order to together form an essentially rigid self-supporting subassembly (16), which can as a uniform entity be transferred and installed on the settler bottom.

18. A settler arrangement according to claim 17, characterized in that the subassembly (16) includes an essentially vertical front wall (17) that is parallel with the overflow chute and is at its upper edge (18) attached to the external side of the overflow chute (10), the lower edge (19) of said front wall extending to the vicinity of the bottom (5) of the settler (6), so that in between the lower edge and the bottom, there is left an aperture (20) that allows the second solution to flow through the aperture to the rising pipes (13).

19. A settler arrangement according to claim 18, characterized in that the subassembly (16) includes support plates (21) that are arranged transversally with respect to the lengthwise direction of the overflow and collecting chutes (10, 12), spaced apart underneath the overflow and collecting chutes, to which support plates (21) the overflow chute (10), the collecting chute (12) and the front wall (17) are attached.

20. A settler arrangement according to claim 19, characterized in that in the support plates (21), there are integrated legs (22) for supporting the subassembly (16) against the bottom (5) of the settler (6).

21. A settler arrangement according to claim 17, characterized in that the collecting chute (12) is semi-circular in cross-section.

22. A settler arrangement according to claim 17, characterized in that the first outlet box (11) is attached underneath the overflow chute (10).

23. A settler arrangement according to claim 17, characterized in that the second outlet box (15) is attached underneath the collecting chute (12).

24. A settler arrangement according to claim 17, characterized in that the subassembly (16) includes a support frame (23) that is rigidly attached with respect to the collecting chute (12) in order to support the level control valve (14).

25. Equipment to be placed in the settler (6) of liquid-liquid extraction, comprising:
an overflow chute (10) for receiving a first solution as an overflow from the settler,
a first outlet box (11) that is placed on a lower level than the overflow chute and arranged to receive the first solution from the overflow chute,
a collecting chute (12) that is arranged adjacently with the overflow chute for receiving the second solution as an underflow from the settler,
rising pipes (13) that extend from the collecting chute to the settler for conducting the second solution to the collecting chute,
level control valves (14) that are arranged in the rising pipes for adjusting the level of the second solution, and
a second outlet box (15) that is placed on a lower level than the collecting chute and arranged to receive the second solution from the collecting chute, characterized in that the both the overflow chute (10) and the collecting chute (12) are semi-circular in cross-section being manufactured by cutting a prefabricated pipe into half, and that the overflow chute (10), the first outlet box (11), the collecting chute (12), the rising pipes (13), the level control valves (14) and the second outlet box (15) are interconnected in order to together form an essentially rigid self-supporting subassembly (16), which can as a uniform entity be transferred and installed on the settler bottom.

26. Equipment according to claim 25, characterized in that the subassembly (16) includes an essentially vertical front wall (17) that is parallel with the overflow chute and is at its upper edge (18) attached to the external side of the overflow chute (10), the lower edge (19) of said front wall extending to the vicinity of the bottom (5) of the settler (6), so that in between the lower edge and the bottom, there is left an aperture (20) that allows the second solution to flow through the aperture to the rising pipes (13).

27. Equipment according to claim 26, characterized in that the subassembly (16) includes support plates (21) that are arranged transversally with respect to the lengthwise direction of the overflow and collecting chutes (10, 12), spaced apart underneath the overflow and collecting chutes, to which support plates the overflow chute (10), the collecting chute (12) and the front wall (17) are attached.

28. Equipment according to claim 27, characterized in that in the support plates (21), there are integrated legs (22) for supporting the subassembly (16) against the bottom (5) of the settler (6).

29. Equipment according to claim 25, characterized in that the collecting chute (12) is semi-circular in cross-section.

30. Equipment according to claim 25, characterized in that the first outlet box (11) is attached underneath the overflow chute (10).

31. Equipment according to claim 25, characterized in that the second outlet box (15) is attached underneath the collecting chute (12).

32. A method for installing the equipment according to claim 25, to be placed in the settler (6) of liquid-liquid extraction,
characterized in that
at the place of manufacture, such as an engineering workshop, the overflow chute (10), the first outlet box (11), the collecting chute (12), the rising pipes (13), the level control valves (14) and the second outlet box (15) are interconnected in order to together form an essentially rigid self-supporting subassembly (16),
the compiled subassembly (16) is transferred as a uniform entity to the site of installation, and
the subassembly (16) is installed at the site of installation on the bottom (5) of the settler (6), to be supported thereby.
